(19) United States
(12) Patent Application Publication
(10) Pub. No.: US 2024/0375886 A1
(43) Pub. Date: Nov. 14, 2024

(54) SLUG LOADING SYSTEMS WITH INDEPENDENTLY DRIVEN LOADING UNITS

(71) Applicant: Johannes G. VAN DER ENT, Ladson, SC (US)

(72) Inventor: Johannes G. VAN DER ENT, Ladson, SC (US)

(21) Appl. No.: 18/660,562

(22) Filed: May 10, 2024

Related U.S. Application Data
(60) Provisional application No. 63/465,355, filed on May 10, 2023.

(51) Int. Cl. B65G 47/68; B65G 47/26

(52) U.S. Cl. CPC B65G 47/681; B65G 47/261; B65G 2201/0205; B65G 2814/0307

(57) ABSTRACT

A system for formation of one or more slugs is provided. The system comprises a first loading unit having one or more first cups and a second loading unit having one or more second cups. The first loading unit and the second loading unit are each configured to receive products therein from a conveyor. The first loading unit and the second loading unit are each configured to move to an unloading position after receiving the products so that the slug(s) are formed. The first loading unit and the second loading unit are each configured to unload the slug(s) when the first loading unit and the second loading unit are in the unloading position. The first loading unit and the second loading unit may be independently driven so that the first loading unit and the second loading unit are configured to move relative to each other.

### CROSS-REFERENCE TO RELATED APPLICATIONS

This application claims the benefit of priority of U.S. Provisional Application Ser. No. 63/465,355, filed on May 10, 2023, which is incorporated herein in its entirety.

### FIELD OF THE INVENTION

Embodiments relate generally to bakery slug loading systems with independently driven loading units.

### BACKGROUND OF THE INVENTION

In the industrial baking industry, two main types of slug-forming equipment exist. Slug-forming equipment receives products so that stacks of products (i.e., slugs) are formed. A first type of slug forming equipment receives baked products from an oven in multiple lanes, with products positioned flat on a conveyor belt. Using a series of belts with different speeds and levels, products are first shingled, after which endless slugs of products, on-edge, are formed. At the end of this conveyor, knives are used to penetrate rows of the products from above. The knives separate a certain number of products to create slugs. However, while knives may be beneficial to penetrate the rows, the knives also create a high risk of damage to the products. Where knives are utilized, products with variations in height, shape, or size are often not able to be handled well.

A second type of slug forming equipment receives baked products flat on a conveyor belt from an oven, with products aligned in rows across the conveyor. At the end of the conveyor, the rows of products will travel over a curve ninety (90) degrees downwards and will be dropped in a cross-conveyor one row at the time. By staggering the spaces in the cross-conveyor, slugs can be formed. However, requiring the products to travel over a curve and then drop ninety (90) degrees downwards subjects the products to a high risk of damage. Additionally, where particularly sensitive products, such as cookies with added particles (candy, nuts, etc.), are used, the products may be degraded in quality by requiring the products to drop for significant distances.

Typical slug forming equipment also frequently operates at relatively low speeds. Oftentimes, some or all of the components of the slug forming equipment are required to be paused to allow other components to reach the appropriate position. For example, conveyors upon which products are placed are frequently required to be stopped so that other loading units can be shifted once the loading units have been filled to full capacity with products.

Additionally, typical slug forming equipment is configured for use with only one-sized product. Without major mechanical changes, such equipment is only able to run one particular size or shape or product. Change of size and shape is therefore difficult, costly, and requires a significant period of time for conversion which means that the systems are offline for extended lengths.

### BRIEF SUMMARY OF THE INVENTION

Slug loading systems are contemplated herein, with the slug loading systems being suitable for use in the industrial baking industry as well as in industries where slugs need to be formed. For example, slug loading systems can be used to form slugs of folded paper or cardboard products such as envelopes and boxes, food chips such as potato chips, pre-packaged and wrapped products (e.g., candy products, auto parts, etc.), face masks, diapers, and female sanitary products. However, slug loading systems can be used to form slugs of other products. The slug loading system may be configured to operate at high speeds. For example, in some embodiments, the slug loading system may be configured to receive as many as two hundred thirty (230), or more, product rows per minute from the conveyor. The slug loading system may also be configured to operate without requiring the conveyor to be momentarily paused so that components of the slug loading system may be moved into position. The slug loading system may comprise a plurality of independently-controlled loading units, and each loading unit may be driven by its own independent drive mechanism, such as gearmotor. By providing independently-controlled loading units, a second loading unit may quickly be shifted into position to receive further products as soon as a first loading unit has been filled to capacity. Additionally, the use of independently-controlled loading units may allow for loading units to be positioned at an unloading position for as long as necessary to unload slugs of products, and other loading units may be moved while one loading unit is unloading.

As products are moved through systems described in various embodiments herein, care may be taken to minimize the damage caused to products and to prevent degradation in the quality of the products. An independently-controlled loading unit may be shifted to a position proximate to a conveyor so that products may be received in the loading unit. As products are received, the loading unit may be moved downwardly in small steps so that further products may be stacked to form slugs. Gates may be provided in the loading unit to ensure that products are secured therein once the loading units have been filled, and the loading unit may be moved to an unloading position. Intermediate cups may be placed in an elevated position just beneath the loading unit when the loading unit is in the unloading position. Thus, once the gates are opened, the products may only be required to fall a small distance from the loading unit to the intermediate cups. The intermediate cups may then be lowered by other equipment so that the intermediate cups may be positioned slightly above a cross feeder. While the intermediate cups are moving into a lower position, they also move horizontally in the transport direction of the cross feeder. Once the intermediate cups are in the lowered position and once the intermediate cups are moving with the same velocity as the cross feeder, the intermediate cups may be moved into an opened state so that products may be permitted to fall only a small distance to the cross feeder. The cross feeder may move the product to another location for further packaging, processing, etc. As the products travel through the system, the products only fall small distances and may be generally subjected to only small forces, allowing the quality of products to be relatively maintained as compared to known systems.

In an example embodiment, a system for formation of one or more slugs is provided. The system comprises a first loading unit having one or more first cups and a second loading unit having one or more second cups. The first loading unit and the second loading unit may each be configured to receive products therein from a conveyor, and the first loading unit and the second loading unit may each be configured to move to an unloading position after receiving the products so that the one or more slugs may be formed. The first loading unit and the second loading unit may each be configured to unload the one or more slugs when the first loading unit and the second loading unit are in the unloading position, and the first loading unit and the second loading unit may be independently driven so that the first loading unit and the second loading unit may move relative to each other.

In some embodiments, the system may comprise additional loading units, such as a third loading unit and possibly four or more loading units. Where a third loading unit is used, the third loading unit may be configured to receive the products therein from the conveyor, and the third loading unit may be configured to move to the unloading position after receiving the products so that at least one slug may be formed. Further, the third loading unit may be configured to unload the at least one slug when the third loading unit is in the unloading position, and the third loading unit may be independently driven so that the third loading unit is configured to move relative to the first loading unit and the second loading unit. In some embodiments, the first loading unit and the second loading unit may each be configured to receive the products therein from a conveyor at different times, the first loading unit and the second loading unit may be configured to reach an unloading position at different times, and the first loading unit and the second loading unit may each be configured to unload the one or more slugs at different times.

In some embodiments, the system further may comprise a wall defining a first cam path that is configured to assist in controlling positioning and orientation of the first loading unit and the second loading unit. Additionally, in some embodiments, the first loading unit may comprise a first follower and the second loading unit may comprise a second follower, and the first cam path may be configured to receive the first follower and the second follower within the first cam path. Furthermore, in some embodiments, the first cam path may be configured to cause the first loading unit and the second loading unit to be positioned proximate to the conveyor to receive the products from the conveyor, and the first cam path may be configured to position and orient the first loading unit and the second loading unit so that they do not contact the conveyor. In some embodiments, while actively receiving the products, the first loading unit and the second loading unit may be moved after the products are received to enable further products to be stacked on top of other products that have already been received in the first loading unit or the second loading unit. Also, in some embodiments, the system also comprises an unloading system, and the first cam path may be configured to cause the first loading unit and the second loading unit to be positioned proximate to an unloading system when in an unloading position, and the first cam path may be configured to position and orient the first loading unit and the second loading unit so that they do not contact the unloading system. Additionally, in some embodiments, the unloading system may comprise intermediate cups. The intermediate cups may be configured to be in a closed state and then raised to an elevated position to receive the one or more slugs from the first loading unit or the second loading unit when the first loading unit and/or the second loading unit is in the unloading position. The intermediate cups may also be configured to be lowered to a lowered position, and the intermediate cups configured to shift to an opened state when in the lowered position to enable the one or more slugs to be released to a cross feeder below.

In some embodiments, the first loading unit and the second loading unit each may comprise one or more gates to selectively retain products in the one or more first cups and the one or more second cups. Furthermore, in some embodiments, the system may also comprise a second cam path defined in the wall and the first loading unit may comprise a first pin, the second cam path may be positioned so that the first pin engages the second cam path after the first loading unit has finished receiving the products to form the one or more slugs, and engagement between the second cam path and the first pin causes the one or more gates of the first loading unit to move to a closed position to retain the one or more slugs in the first loading unit.

In some embodiments, the second cam path may be positioned so that the first pin stops engaging the second cam path once the first loading unit has reached the unloading position, and disengagement between the second cam path and the first pin causes the one or more gates of the first loading unit to move to an opened position to allow the one or more slugs to be released from the first loading unit.

In some embodiments, the first loading unit may be driven by a first set of at least two gear boxes, a first gearmotor, and a first drive shaft. Additionally, in some embodiments, the second loading unit may be driven by a second set of at least two gear boxes, a second gearmotor, and a second drive shaft.

In some embodiments, the first loading unit and the second loading unit may each be configured to receive rows of products therein from a conveyor, and the system may be configured to receive 100 rows of products per minute. Additionally, in some embodiments, the system may be configured to receive 230 rows of products, or more, per minute.

In another example embodiment, a system for formation of one or more slugs is provided. The system comprises a first slug loading system comprising a first loading unit having one or more first cups and a second loading unit having one or more second cups. The system also comprises a conveyor and an unloading system. The first loading unit and the second loading unitmay each be configured to receive products therein from the conveyor. The first loading unit and the second loading unit may each be configured to move to an unloading position after receiving the products so that the one or more slugs may be formed, and the first loading unit and the second loading unit may each be configured to unload the one or more slugs when the first loading unit and the second loading unit are in the unloading position. The first loading unit and the second loading unit may be independently driven so that the first loading unit and the second loading unit may be configured to move relative to each other.

In some embodiments, the system may also include a second slug loading system. The second slug loading system may comprise a third loading unit having one or more third cups and a fourth loading unit having one or more fourth cups. The third loading unit and the fourth loading unit may each be configured to receive products therein from the conveyor. The third loading unit and the fourth loading unit may each be configured to move to a second unloading position after receiving the products so that the one or more slugs may be formed. The third loading unit and the fourth loading unit may each be configured to unload the one or more slugs when the third loading unit and the fourth loading unit are in the unloading position, and the third loading unit and the fourth loading unit may be independently driven so that the third loading unit and the fourth loading unit may be configured to move relative to each other. The first slug loading system may be configured to operate with products having a first size, and the second slug loading system may be configured to operate with products having a second size. In some embodiments, only one of the first slug loading system or the second slug loading system is operative at any given time.

### BRIEF DESCRIPTION OF THE DRAWINGS

Reference will now be made to the accompanying drawings, which are not necessarily drawn to scale, and wherein:

FIG. 1A is a perspective view illustrating an example slug loading system, in accordance with some embodiments discussed herein;

FIG. 1B is an enhanced, perspective view illustrating a cup of a first loading unit in the slug loading system of FIG. 1A, in accordance with some embodiments discussed herein;

FIG. 2A is a perspective view illustrating the example slug loading system of FIG. 1A, in accordance with some embodiments discussed herein;

FIG. 2B is a side view illustrating an example slug loading system of FIG. 2A where a machine side is hidden from one side of the slug loading system so that other components may be more easily seen, in accordance with some embodiments discussed herein;

FIG. 3 is a side view illustrating the example slug loading system of FIG. 2B where the loading units have each shifted relative to their illustrated positions in FIG. 2B and where a machine side is hidden from one side of the slug loading system so that other components may be more easily seen, in accordance with some embodiments discussed herein;

FIG. 4 is a side view illustrating the example slug loading system of FIG. 2B where the loading units have each shifted relative to their illustrated positions in FIG. 2B and FIG. 3, in accordance with some embodiments discussed herein;

FIG. 5A is a perspective view illustrating a system comprising the slug loading system of FIG. 1A, an unloading system, and a cross feeder, in accordance with some embodiments discussed herein;

FIG. 5B is a side view illustrating the system of FIG. 5A where a machine side is hidden from one side of the slug loading system so that other components may be more easily seen, in accordance with some embodiments discussed herein;

FIG. 6A is a perspective view illustrating the system of FIG. 5A where a rack used to hold intermediate cups is repositioned underneath the slug loading system after slugs have been positioned on the intermediate cups, in accordance with some embodiments discussed herein;

FIG. 6B is a side view illustrating the slug loading system within the system of FIG. 6A where a machine side is hidden from one side of the slug loading system so that other components may be more easily seen, in accordance with some embodiments discussed herein;

FIG. 7A is a perspective view illustrating the slug loading system of FIG. 1A where a machine side is hidden from one side of the slug loading system so that other components may be more easily seen, in accordance with some embodiments discussed herein;

FIG. 7B is a schematic view illustrating a reinforcement bar having lubrication inlet holes and lubrication outlet holes, in accordance with some embodiments discussed herein;

FIG. 8A is a perspective view illustrating the first loading unit of the slug loading system of FIG. 1A, with the first loading unit comprising cups that may be configured to receive slugs of products therein, in accordance with some embodiments discussed herein;

FIG. 8B is a side view illustrating the first loading unit of FIG. 8A, in accordance with some embodiments discussed herein;

FIG. 9 is a perspective view illustrating another example loading unit having cups with a reduced size relative to the cups of the first loading unit illustrated in FIG. 8A, in accordance with some embodiments discussed herein;

FIG. 10A is a perspective view illustrating an example system comprising multiple slug loading systems, with a second slug loading system being operative and with a first slug loading system being inoperative, in accordance with some embodiments discussed herein;

FIG. 10B is a perspective view illustrating the example system of FIG. 10A where the first slug loading system is operative and the second slug loading system is inoperative, in accordance with some embodiments discussed herein;

FIG. 11A is a perspective view illustrating slugs of products being retained in cups by gates, in accordance with some embodiments discussed herein;

FIG. 11B is an enhanced perspective view illustrating the slugs of products of FIG. 11A being retained in the cups by the gates, in accordance with some embodiments discussed herein;

FIG. 11C is a perspective view illustrating the slugs of products resting in intermediate cups after the gates on cups are opened, in accordance with some embodiments discussed herein;

FIG. 11D is a perspective view illustrating slugs of products being moved out from underneath the slug loading system using a cross feeder, in accordance with some embodiments discussed herein;

FIG. 12A is a perspective view illustrating portions of an unloading system where a rack used to hold intermediate cups is positioned in a lowered position, in accordance with some embodiments discussed herein;

FIG. 12B is a perspective view illustrating the portions of the unloading system of FIG. 12B where a rack used to hold intermediate cups is in an elevated position, in accordance with some embodiments discussed herein; and

FIG. 13 is a block diagram illustrating various electrical components and other components within the example system, in accordance with some embodiments discussed herein.

### DETAILED DESCRIPTION OF THE INVENTION

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. The following embodiments and aspects thereof are described and illustrated in conjunction with systems, tools and methods which are meant to be exemplary and illustrative and not limiting in scope. In various embodiments one or more of the above-described problems have been reduced or eliminated while other embodiments are directed to other improvements.

Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto

Exemplary embodiments now will be described more fully hereinafter with reference to the accompanying drawings, in which some, but not all embodiments are shown. Like reference numerals generally refer to like elements throughout. For example, reference numerals 104, 904, and 1104 each refer to a loading unit. Additionally, any connections or attachments may be direct or indirect connections or attachments unless specifically noted otherwise.

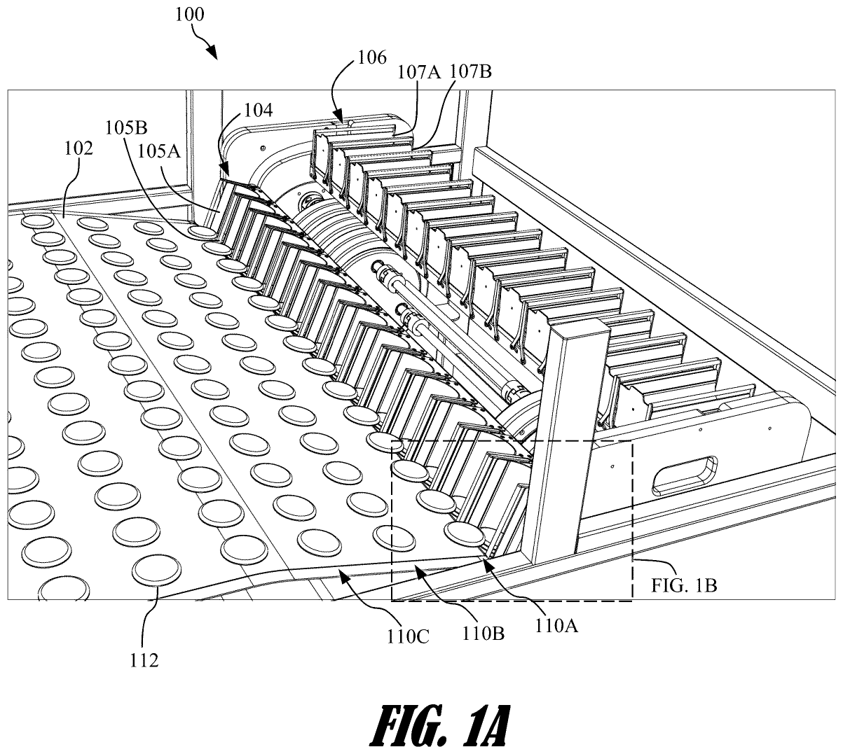

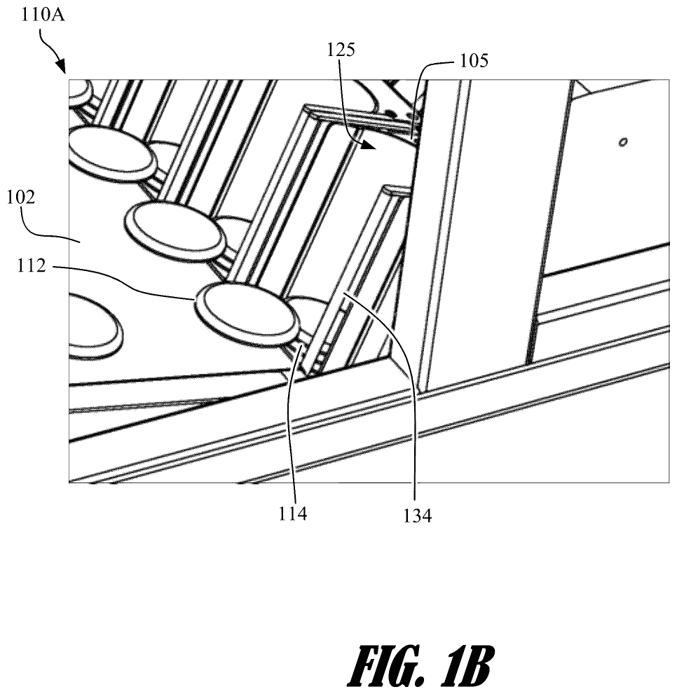

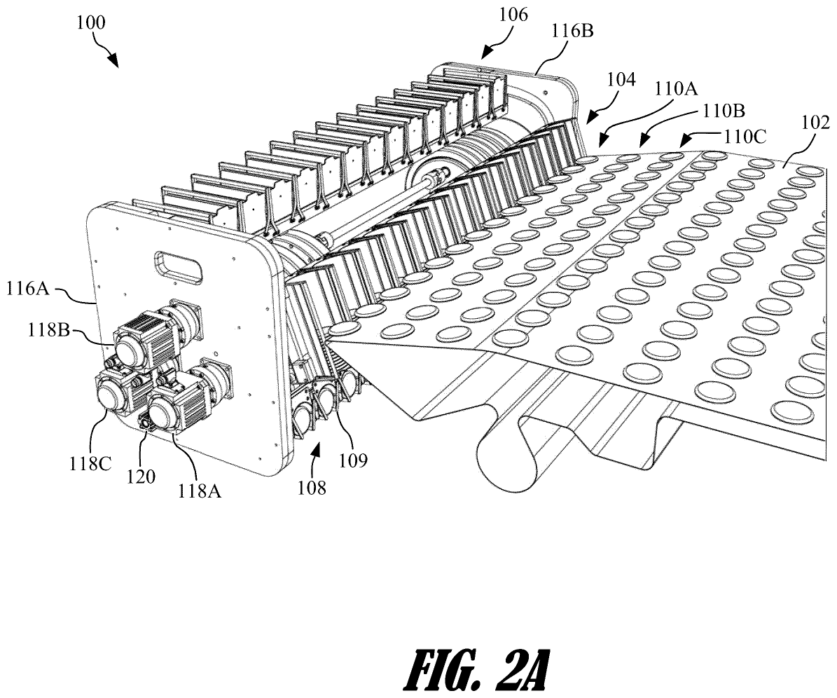

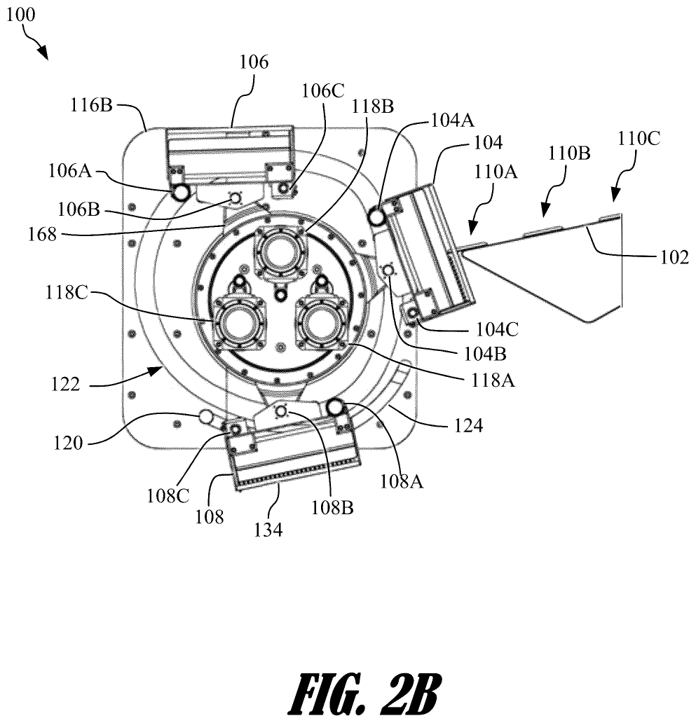

FIG. 1A is a perspective view illustrating an example slug loading system 100. The slug loading system 100 comprises three loading units. The loading units 104, 106, 108 (shown in FIGS. 2A and 2B) may each be independently driven relative to each other. A first loading unit 104 is illustrated with a plurality of cups formed within the first loading unit 104. For example, a first cup 105A, a second cup 105B, and several more cups are illustrated in the first loading unit 104. The second loading unit 106 is illustrated with a first cup 107A, a second cup 107B, and several more cups in the second loading unit 106. A third loading unit 108 (see FIG. 2B) may also be provided in the slug loading system 100 that may be similar to the first loading unit 104 and the second loading unit 106.

Each of the loading units 104, 106, 108 may comprise a similar number of cups. For example, in the embodiment illustrated in FIG. 1A, the loading units 104, 106, 108 each comprise fourteen (14) cups, with each cup defining a slot where products may be received. Products 112 are also illustrated. The products 112 may possess a variety of different forms. For example, the products 112 may be food products such as cookies, potato chips, hamburger patties, etc. However, products other than food products are also contemplated and may be used in the described slug loading systems. Food products may be cooked or baked when provided to the slug loading system 100 and other systems described herein. Alternatively, food products may be frozen or uncooked. Slug loading systems can also be used to form slugs of folded paper or cardboard products such as envelopes and boxes, food chips such as potato chips, pre-packaged and wrapped products (e.g., candy products, auto parts, etc.), face masks, diapers, and female sanitary products. However, slug loading systems can be used to form slugs of other products.

The slug loading system 100 may be configured to operate with products 112 having a variety of different sizes. For example, the slug loading system 100 may be configured to operate with products having a size of between 0.5 inches in diameter to 8 inches in diameter in some embodiments. The slug loading system 100 may be configured to operate with products having a size of between 1 inch in diameter to 6 inches in diameter in some embodiments. The slug loading system 100 may be configured to operate with products having a size of between 1.5 inches in diameter to 5 inches in diameter in some embodiments. Additionally, the slug loading system 100 may be configured to operate with products having a size of between 1.75 inches in diameter and 4 inches in diameter in some embodiments. Other sizes, depending on the desired product, may also be utilized.

Products 112 may be provided on the conveyor 102. The conveyor 102 may be a flat-belt conveyor, and the conveyor 102 may be configured to move the products 112 towards the first loading unit 104 where the products 112 may be positioned in the slots formed in the cups of the first loading unit 104.

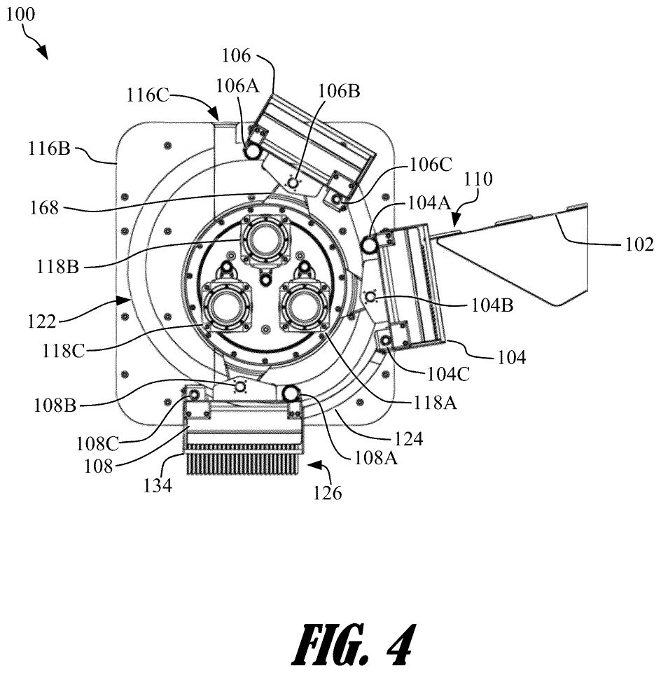

The products 112 may be positioned so that products form product rows. Appropriate positioning of products 112 in product rows may be monitored through the use of sensors. By positioning products 112 in product rows, the products 112 in each row reach the first loading unit 104 at approximately the same time. For example, a first product row 110A, a second product row 110B, and a third product row 110C are illustrated in FIG. 1A. The first product row 110A will reach the first loading unit 104 first. As illustrated in FIG. 1B, if any products 114 have already been positioned in the first loading unit 104, then the products 112 in the first product row 110A may be positioned on top of the previously positioned products 114 in slots 125 formed by cups 105 of the first loading unit 104. Gates 134 may be provided on each of the cups 105. The gates 134 may comprise stainless steel material in some embodiments, but the gates 134 may comprise other materials as well. In some embodiments, the gates 134 may be spring-loaded. The gates 134 are shown as open in FIG. 1B so that products 112 may enter the slots 125 formed by the cups 105. However, once the cups 105 have been filled to full capacity with products 112 to form slugs 126 (see FIG. 4), the gates 134 may be closed so that the slugs 126 may be retained in the cups 105. In some embodiments, the full capacity level in each cup 105 may be programmed and changeable during production. For example, an operator may change the full capacity level based on a number of products that may be received in the cup 105 or based on the height or volume of products in the cup 105.

After the products 112 of the first product row 110A have been positioned in the first loading unit 104, the products 112 of the second product row 110B may be positioned in the first loading unit 104. The products 112 of the second product row 110B may be positioned on top of the previously positioned products of the first product row 110A. Then, the products 112 of the third product row 110C may be positioned in the first loading unit 104, and the products 112 of the third product row 110C may be positioned on top of the previously positioned products of the second product row 110B.

Additionally, the products 112 may be positioned in each product row with the appropriate spacing so that the products 112 will be positioned appropriately relative to a cup 105 in the first loading unit 104. For example, one product 112 in the first product row 110A is positioned so that it will extend into the slot formed by the first cup 105A of the first loading unit 104, another product 112 in the first product row 110A is positioned so that it will extend into the slot formed by the second cup 105B of the first loading unit 104, and other products 112 in the first product row 110A may be positioned similarly on the conveyor 102. This positioning may be facilitated by guides provided on the conveyor 102.

In some embodiments, the slug loading system 100 may be configured to operate at high speeds. For example, the slug loading system 100 may be configured to receive one hundred (100) or more product rows per minute from the conveyor 102 in some embodiments, the slug loading system 100 may be configured to receive one hundred twenty-five (125) or more product rows per minute from the conveyor 102 in some embodiments, the slug loading system 100 may be configured to receive one hundred fifty (150) or more product rows per minute from the conveyor 102 in some embodiments, the slug loading system 100 may be configured to receive one hundred seventy-five (175) or more product rows per minute from the conveyor 102 in some embodiments, or the slug loading system 100 may be configured to receive two hundred (200) or more product rows per minute from the conveyor 102 in some embodiments. In some embodiments, the slug loading system 100 may even be configured to receive two hundred thirty (230) or more product rows per minute from the conveyor 102. The slug loading system 100 may be configured to accomplish these high speeds without requiring the conveyor 102 to be stopped, which may be beneficial to ensure that each of the products 112 remain appropriately positioned on the conveyor 102.

Further features of the slug loading system 100 are illustrated in FIG. 2A. Driving mechanisms, such as a first gearmotor 118A, a second gearmotor 118B, and a third gearmotor 118C may be installed in the machine side 116A. Each of the gearmotors 118A, 118B, 118C may be servo electro gearmotors, but other types of motors may be used for the gearmotors 118A, 118B, 118C. Each of the gearmotors 118A, 118B, 118C may be configured to independently control the positioning of the loading units 104, 106, 108. For example, the first gearmotor 118A may be configured to independently control the positioning of the first loading unit 104 to cause the first loading unit 104 to move relative to the other two loading units 106, 108. Further, the second gearmotor 118B may be configured to independently control the positioning of the second loading unit 106, and the third gearmotor 118C may be configured to independently control the positioning of the third loading unit 108.

Additionally, extensions 120 may be installed in the machine side 116A and in machine side 116B. The extensions 120 may be pneumatically controlled so that the extensions 120 may be provided in an extended or retracted position. However, the extensions 120 may also be hydraulically controlled or controlled in other ways as well. As described further herein, the extensions 120 may be configured to hold the gates 134 for each of the loading units 104, 106, 108 in a closed position or an open position.

Further details regarding the operation of the loading units 104, 106, 108 are illustrated in FIG. 2B. In FIG. 2B, the machine side 116A (see FIG. 2A) is hidden so that other components of the slug loading system 100 may be more easily seen. The machine sides 116A, 116B may both define a first cam path 122. The first cam paths 122 may be specially designed to create a unique and consistent motion for the loading units 104, 106, 108. The loading units 104, 106, 108 each define a follower. The first loading unit 104 comprises a follower 104A, the second loading unit 106 comprises a follower 106A, and the third loading unit 108 comprises a follower 108A. The followers 104A, 106A, 108A may each be received in the first cam paths 122 to enable the first cam paths 122 to control the positioning and orientation of the loading units 104, 106, 108. In some embodiments, the portion of the machine sides 116A, 116B where the first cam paths 122 are defined may comprise Ultra High Molecular Weight polyethylene (UHMW) material, but other materials may also be utilized.

Additionally, the loading units 104, 106, 108 may each be configured to rotate about a pivot. The first loading unit 104 may be configured to rotate about a pivot 104B, the second loading unit 106 may be configured to rotate about a pivot 106B, and the third loading unit 108 may be configured to rotate about a pivot 108B. By positioning the followers 104A, 106A, 108A in the first cam paths 122 and by attaching the loading units 104, 106, 108 to the remainder of the slug loading system 100 with the pivots 104B, 106B, 108B, the positioning and orientation of the loading units 104, 106, 108 may be controlled. The arms 168 that the pivots 104B, 106B, 108B are connected to may be configured to rotate independently of each other. The pivots 104B, 106B, 108B and other pivots described herein may comprise stainless steel and may be spring-loaded.

The three loading units 104, 106, 108 are each performing different tasks in FIG. 2B. The first loading unit 104 is actively receiving product rows 110A, 110B, 110C from the conveyor 102. The second loading unit 106 is empty, and the second loading unit 106 is shifting clockwise along the first cam paths 122 towards the position where the first loading unit 104 is located. As soon as the first loading unit 104 has reached full capacity, the first loading unit 104 may be moved clockwise along the first cam paths 122 and the second loading unit 106 may be quickly moved clockwise along the first cam paths 122 so that the second loading unit 106 may receive further product rows. The second loading unit 106 may be configured to quickly move clockwise along the first cam paths 122 so that the conveyor may be continuously operated without stopping for the second loading unit 106 to move into position.

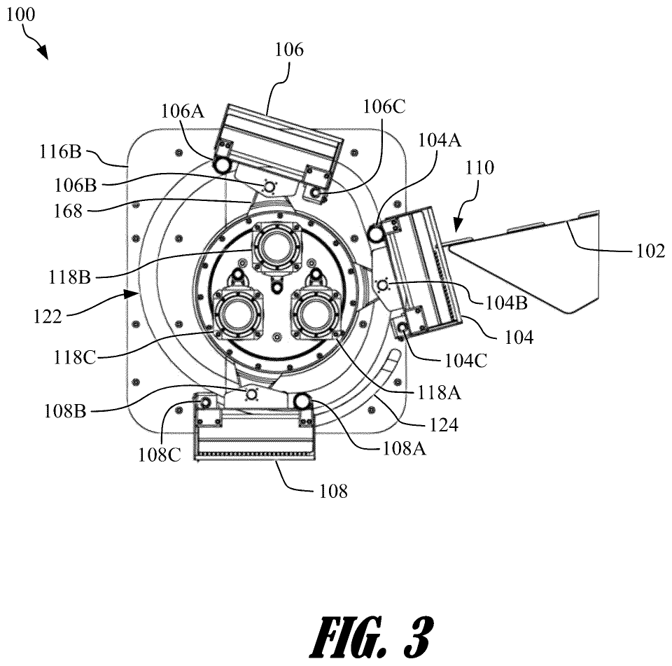

Each of the cups 109 (see FIG. 2A) of the third loading unit 108 may be filled with slugs of products. In FIG. 2B, the gates 134 of the third loading unit 108 may be in a closed position to retain the slugs of products in the cups 109. The second cam path 124 extends outwardly from the machine side 116B relative to other portions so that the second cam path 124 extends farther in a direction towards the viewer in FIG. 3 relative to other portions of the machine side 116B. The machine side 116A may possess a similar second cam path 124. The third loading unit 108 comprises a pin 108C on each side of the third loading unit, and these pins 108C may engage the second cam paths 124 as the third loading unit 108 moves clockwise along the first cam paths 122. Engagement of the pins 108C and the second cam paths 124 causes the gates 134 to close, and the gates 134 remain open at other times when there is no engagement between the pins 108C and the second cam paths 124. The extensions 120 may be provided at the end of the second cam paths 124. When the extensions 120 are in the extended position, the end surface of the extensions 120 may be flush with the surface of the second cam paths 124. The first loading unit 104 comprises a pin 104C on each side of the first loading unit 104, the second loading unit 106 also comprises a pin 106C on each side of the second loading unit 106, and the pins 104C, 106C may each operate similar to the pins 108C of the third loading unit 108.

FIG. 3 illustrates the exemplary slug loading system 100 of FIG. 2B where the loading units 104, 106, 108 have each shifted relative to their illustrated positions in FIG. 2B. The first loading unit 104 may be configured to travel down along the first cam paths 122 in step distances after each successive row 110 of products has been received in slots formed by cups of the first loading unit 104. The appropriate distance for the step distances may be dependent upon the type of product and/or the size of the product. When a row is placed in the loading cups the cups will travel down a programmed step down. The first cam paths 122 may be configured to cause the first loading unit 104 to generally maintain the same distance from the conveyor 102 as the first loading unit 104 is actively receiving the products. For example, while the first loading unit 104 is positioned in different positions relative to the first cam path 122 in FIG. 2B and FIG. 3, the products travel approximately the same distance from the conveyor 102 to their resting position in the first loading unit 104.

In FIG. 3, the second loading unit 106 has rotated further clockwise relative to its position in FIG. 2. Additionally, in FIG. 3, the third loading unit 108 has reached the unloading position. At this unloading position, the third loading unit 108 may be oriented horizontally, and this horizontal orientation may be achieved as a result of the shape of the first cam paths 122. In the unloading position, the pins 108C of the third loading unit 108 may be positioned against the end surface of the extensions 120. The extensions 120 may initially be in an extended position so that the end surfaces of the extensions 120 may be flush with the surfaces of the second cam paths 124. However, once the third loading unit 108 reaches the unloading position and the motion of the third loading unit 108 stops, the extension 120 may be moved to a retracted position to disengage or reduce the amount of force acting on the pin 108C. The extension 120 may be pneumatically moved to the retracted position or to the extended position. This causes the gates 134 of the third loading unit 108 to open so that the slugs 126 of products therein may be allowed to fall.

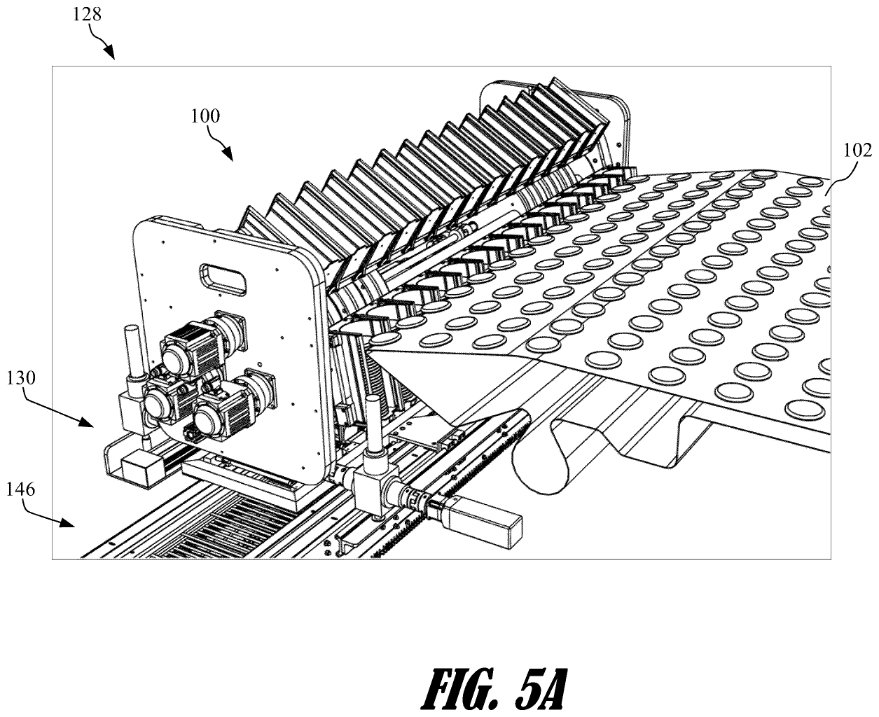

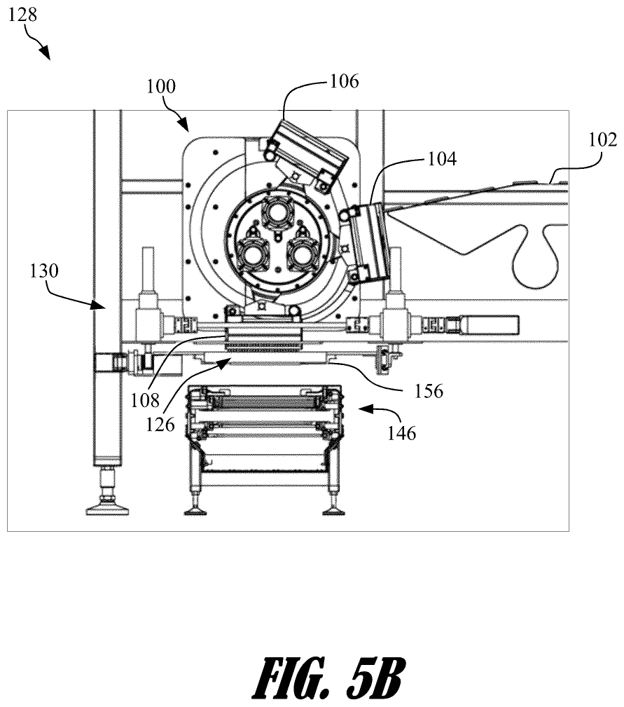

FIG. 4 illustrates the example slug loading system 100 where the third loading unit 108 is positioned at the unloading position with the gates 134 open. Thus, the slug 126 of products in the third loading unit 108 are allowed to fall to an unloading system 130 (see FIG. 5B). The unloading system 130 may be positioned below the slug loading system 100 so that the slug 126 may only be allowed to fall for a small distance, and this may be beneficial to prevent the products in the slug 126 from getting damaged. In some embodiments, the unloading system 130 may be configured to receive the slug 126 so that the slug 126 may only be required to fall 20 millimeters or less.

In FIG. 4, the first loading unit 104 and the second loading unit 106 have also moved relative to their illustrated positions in FIG. 3. The first loading unit 104 has been moved further in the clockwise direction along the first cam paths 122 so that further product rows 110 may be received in the first loading unit 104. Additionally, the second loading unit 106 has been rotated further in the clockwise direction so that the second loading unit 106 may be positioned closer to the first loading unit 104.

FIG. 4 also illustrates an opening 116C formed at the machine side 116B, and a similar opening may be provided at the machine side 116A. The opening 116C may extend from the top wall of the machine side 116B to the first cam path 122. To remove any of the loading units 104, 106, 108, the loading units 104, 106, 108 may be rotated so that its respective followers 104A, 106A, 108A are positioned at the openings 116C, and then the followers 104A, 106A, 108A may be shifted through the openings 116C so that the respective loading unit 104, 106, 108 may be removed. Removal of the loading units 104, 106, 108 may also require disengagement or removal of the pivots 104B, 106B, 108B.

The slug loading system 100 may form part of a larger system 128. FIGS. 5A-5B provide various views illustrating the system 128. As illustrated in FIG. 5A, the system 128 comprises the conveyor 102, the slug loading system 100, and the unloading system 130. The unloading system 130 may be positioned below the slug loading system 100, and the unloading system 130 may comprise the cross feeder 146.

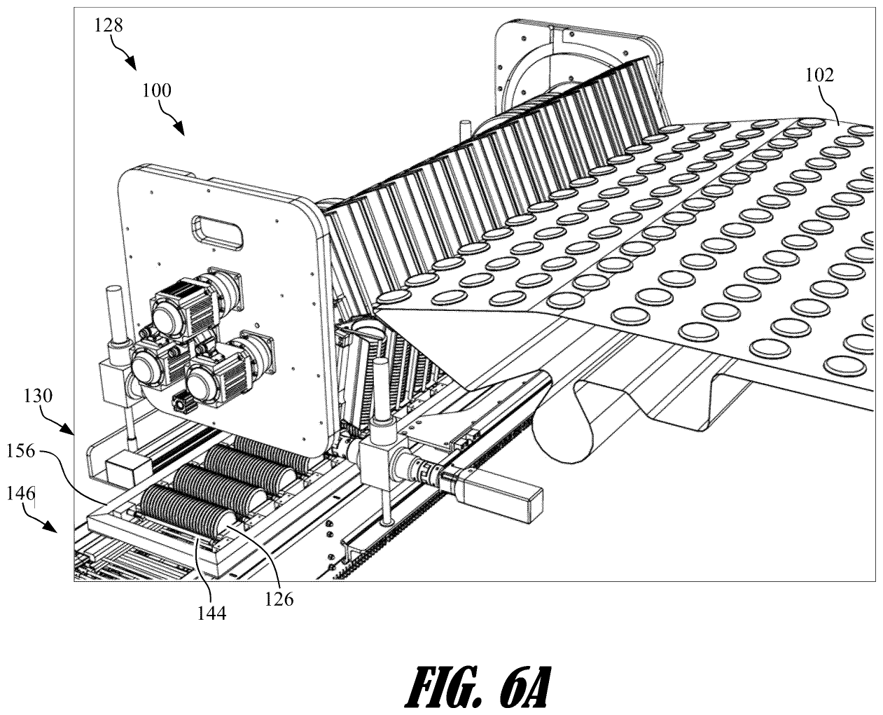

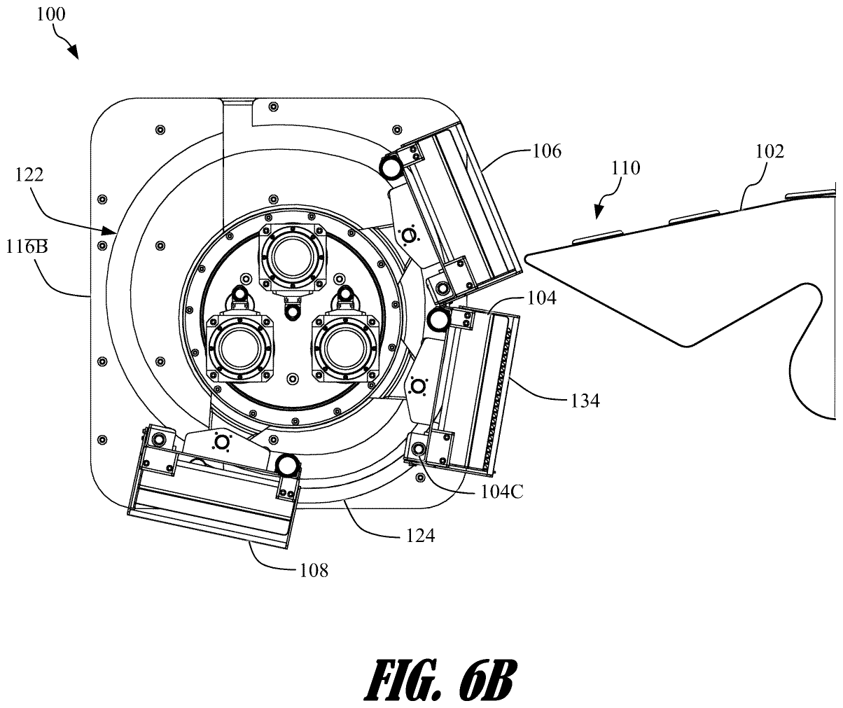

As shown in FIG. 5B, the third loading unit 108 is in the unloading position, and the first loading unit 104 and the second loading unit 106 may also reach this unloading position. When loading units 104, 106, 108 reach the unloading position, the gates 134 of the respective loading unit 104, 106, 108 may be opened, and slugs 126 may be allowed to fall a small distance to the unloading system 130. In FIG. 5B, the slugs 126 may be allowed to fall directly to intermediate cups 144 (see FIG. 6A) in the rack 156. However, in other embodiments, the unloading system 130 may additionally or alternatively possess other components that may be configured to receive the slugs 126. In FIG. 5B, once the slugs 126 have been received in the intermediate cups 144, the unloading system 130 may be configured to lower the intermediate cups 144 and the rack 156 downwardly to the cross feeder 146, and the intermediate cups 144 may be moved to an opened state so that slugs 126 may be positioned on the cross feeder 146.

Looking now at FIG. 6A, slugs 126 are illustrated as being retained in intermediate cups 144. The intermediate cups 144 are illustrated in a closed state to hold the slugs 126, but the intermediate cups 144 may be shifted to an opened state to allow the slugs 126 to be lowered to the cross feeder 146. Once on the cross feeder 146, the slugs may be moved along the cross feeder 146 so that the slugs 126 may be moved to another location away from the slug loading system 100. The cross feeder 146 may be continuously moving in some embodiments. However, in other embodiments, the cross feeder 146 may be moving at some times but not at others.

FIG. 6B is a side view illustrating the slug loading system 100 and conveyor 102 within the system 128 of FIG. 6A. At this stage, the first loading unit 104 has been filled with products so that the first loading unit 104 has received a full slug 126. The first loading unit 104 may be quickly moved along the first cam paths 122 in the clockwise direction so that the second loading unit 106 may be positioned adjacent to the conveyor 102. The first loading unit 104 then continues to move along the first cam paths 122 in the clockwise direction until the first loading unit 104 reaches the unloading position. In FIG. 6B, the pin 104C engages the second cam path 124 so that the gates 134 of the first loading unit 104 may be closed.

The second loading unit 106 may rest slightly above the first loading unit 104 when the first loading unit 104 is receiving its last product row 110, and the second loading unit 106 may quickly move along the first cam paths 122 in the clockwise direction once the first loading unit 104 has been filled to full capacity. Thus, the second loading unit 106 may be rotated into position without requiring the conveyor 102 to be paused.

In FIG. 6B, the third loading unit 108 is empty after unloading slugs 126 at the unloading position. The third loading unit 108 is moving away from the unloading position along the first cam paths 122 in the clockwise direction. The first cam paths 122 may be configured to prevent the third loading unit 108 from touching an unloaded slug 126 as the third loading unit 108 is moving away from the unloading position. The third loading unit 108 eventually rotates to the position where the second loading unit 106 is located to receive further product rows 110.

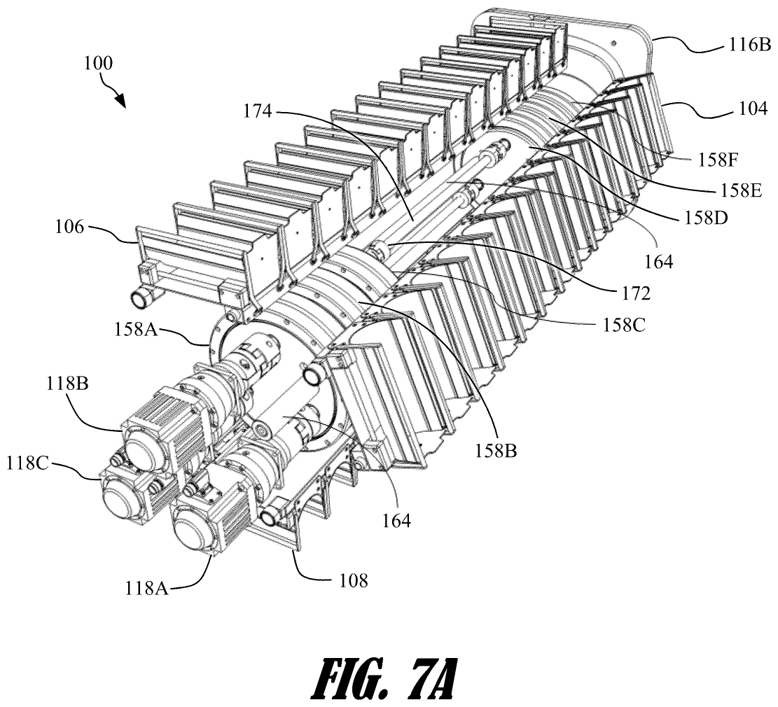

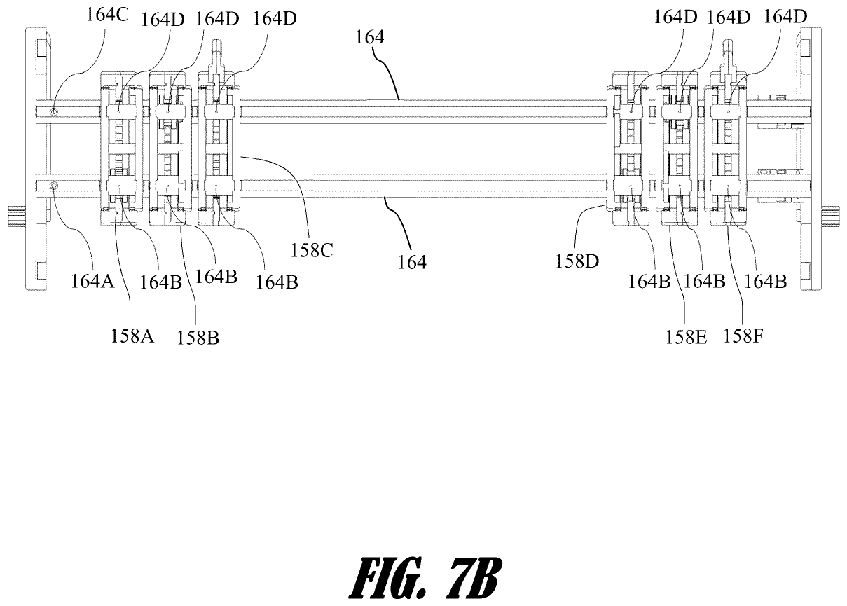

Further details of the slug loading system may be seen in FIG. 7A. In the illustrated embodiment in FIG. 7A, a machine side 116B is provided on the far end of the slug loading system 100, but the machine side 116A (see FIG. 2A) on the near end of the slug loading system 100 is not shown so that other features of the slug loading system 100 may be more easily seen.

As discussed already herein, the slug loading system 100 may comprise a first loading unit 104, a second loading unit 106, and a third loading unit 108. The slug loading system 100 also may comprise a first gearmotor 118A, a second gearmotor 118B, and a third gearmotor 118C. Movement of each of the loading units 104, 106, 108 may be facilitated independently by one of the gearmotors 118A, 118B, 118C. For example, movement of the first loading unit 104 may be facilitated by the first gearmotor 118A, movement of the second loading unit 106 may be facilitated by the second gearmotor 118B, and movement of the third loading unit 108 may be facilitated by the third gearmotor 118C.

The slug loading system 100 also comprises a plurality of gear boxes. A first gear box 158A, a second gear box 158B, a third gear box 158C, a fourth gear box 158D, a fifth gear box 158E, and a sixth gear box 158F may be provided. The gear boxes 158A-158F may each be minimum backlash gearboxes. The first loading unit 104 may be attached to the first gear box 158A and the fourth gear box 158D via arms 168 (see FIG. 2B), and the first gearmotor 118A may be configured to generate movement at certain portions of the first gear box 158A and the fourth gear box 158D to generate movement of the first loading unit 104. The first gear box 158A and the fourth gear box 158D may be coupled by a drive shaft 174 having flexible couplings 172, and the flexible couplings 172 may permit increased ease of maintenance. The second loading unit 106 may be attached to the second gear box 158B and the fifth gear box 158E via arms 168, and the second gearmotor 118B may be configured to generate movement at certain portions of the second gear box 158B and the fifth gear box 158E to generate movement of the second loading unit 106. The second gear box 158B and the fifth gear box 158E may be coupled by a drive shaft 174 having flexible couplings 172. The third loading unit 108 may be attached to the third gear box 158C and the sixth gear box 158F via arms 168, and the third gearmotor 118C may be configured to generate movement at certain portions of the third gear box 158C and the sixth gear box 158F to generate movement of the third loading unit 108. The third gear box 158C and the sixth gear box 158F may be coupled by a drive shaft 174 having flexible couplings 172. Drive shafts 174 may be running in twelve (12) sealed bearings, and the bearings may be lifetime lubricated bearings.

The gear boxes 158A-158F each comprise stationary portions and portions that rotate with the loading units 104, 106, 108. A plurality of reinforcement bars 164 extend through stationary portions of gear boxes 158A-158F to provide increased strength to the slug loading system 100. The reinforcement bars 164 may be stainless steel bars. The reinforcement bars 164 may also be heavy duty bars, and reinforcement bars 164 may be hollow in some embodiments.

As illustrated in FIG. 7B, lubrication may be inserted into the reinforcement bars 164 that may be hollow at lubrication feeding holes 164A, which may be positioned at the end of the reinforcement bars 164. Lubrication may be dispensed through lubrication outlet holes 164B to provide lubrication to all of the gearboxes 158A-158F. The oil and over pressure will be released through return lubrication holes 164D and received by an oil filter, which may be connected to opening 164C. However, in some embodiments, no lubrication is provided for the gear boxes 158A-158F.

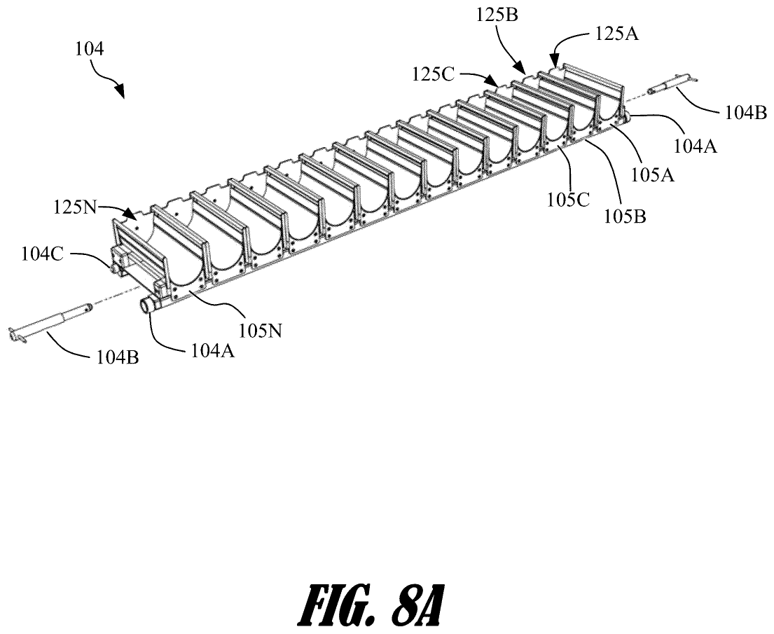

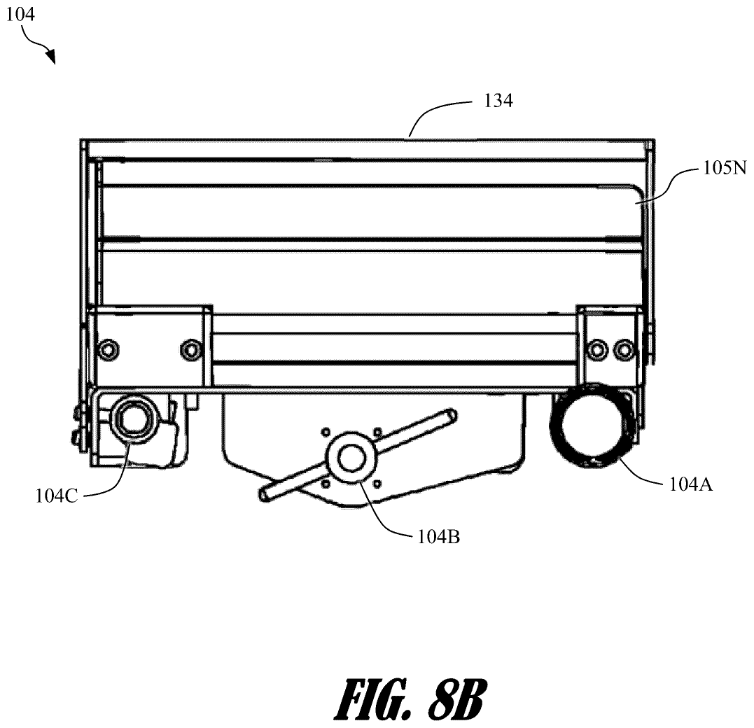

The slug loading system 100 comprises a plurality of loading units 104, 106, 108, and the first loading unit 104 is illustrated in isolation in FIGS. 8A and 8B. The first loading unit 104 is illustrated in a perspective view in FIG. 8A. The first loading unit 104 includes cups that may be configured to receive slugs of products therein. For example, the first loading unit 104 includes a 20 first cup 105A, a second cup 105B, a third cup 105C, and a final cup 105N. The first loading unit 104 includes fourteen cups. However, in other embodiments, loading units may possess a different number of cups or the cups may be provided in different sizes. Each of the cups may form a slot that may be configured to receive products therein. For example, the first cup 105A forms a first slot 125A, the second cup 105B forms a second slot 125B, the third cup 105C forms a third slot 125C, and the final cup 105N forms a final slot 125N. One or more of the walls of the cups may possess a radial shape.

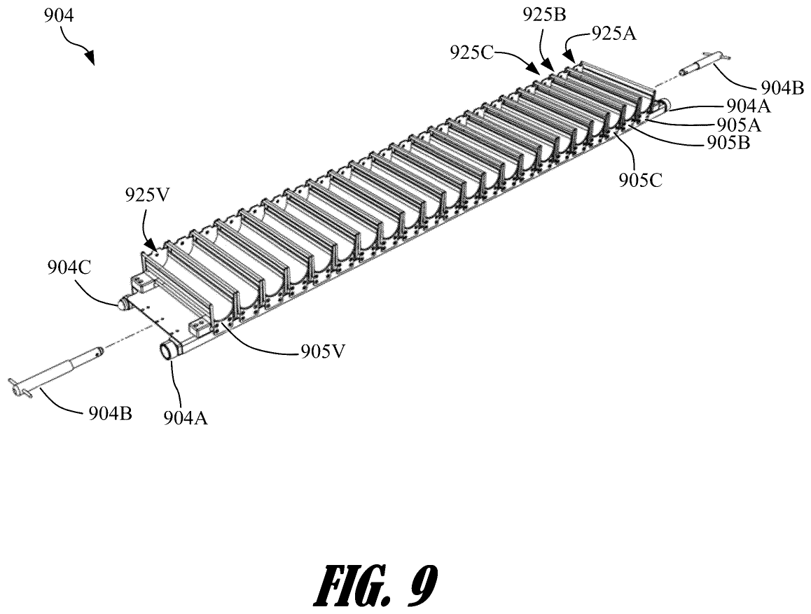

As illustrated in FIGS. 8A and 8B, the first loading unit 104 also comprises a follower 104A on each end, a pivot 104B on each end, and a pin 104C on each end. The follower 104A and the pin 104C may each protrude outwardly from each end relative to other portions of the first loading unit 104. Additionally, the pivots 104B may be inserted or removed to enable the first loading unit 104 to be easily installed or removed from the slug loading system 100. The gates 134 of the final cup 105N of the first loading unit 104 are also visible in FIG. 8B.

Where the system 128 is utilized to form products having a different size, the first loading unit 104 may need to be replaced to effectively receive the products. For example, where products do not fit the range of sizes for the first loading unit 104, the first loading unit 104 may be replaced with loading unit 904 illustrated in FIG. 9. The second loading unit 106 and the third loading unit 108 may also be replaced with a similar loading unit 904.

As shown in FIG. 9, the loading unit 904 may be similar to the first loading unit 104 in terms of the overall size and shape of the loading units, and the size, shape, and positioning of the followers 904A, pivots 904B, and the pins 904C in the loading unit 904 may each be similar to the followers 104A, pivots 104B, and pins 104C of the first loading unit 104. Thus, the loading unit 904 may be easily substituted in place of the first loading unit 104.

The loading unit 904 of FIG. 9 includes twenty-two cups, with a first cup 905A, a second cup 905B, a third cup 905C, and a final cup 905V illustrated in FIG. 9. Each of the cups defines a slot. For example, the first cup 905A defines a first slot 925A, the second cup 905B defines a second slot 925B, the third cup 905C defines a third slot 925C, and the final cup 905V defines a final slot 925V. Given the greater number of cups and the potentially smaller size of the products provided in the cups, the loading unit 904 may be capable of holding an increased number of products relative to the first loading unit 104 of FIG. 8A.

Replacement of the loading units may occur within minutes. For example, to replace the first loading unit 104 with the loading unit 904, the first loading unit 104 may be moved to a location proximate to the openings 116C, the pivots 104B may be removed on each side, and the followers 104A may be shifted out of the openings 116C. Then, the loading unit 904 may be installed by shifting the followers 904A into the openings 116C so that the followers 904A may be provided in the first cam paths 122 and the pivots 904B may be installed on each side of the loading unit 904. The ability to easily remove the loading units also improves the ability to thoroughly sanitize the slug loading system 100.

As illustrated by FIGS. 8A and 9, loading units may possess a variety of shapes and sizes. In some embodiments, the slug loading system 100 may be configured to accept products having a diameter ranging from 35 millimeters to 75 millimeters with production lanes, and the slug loading system 100 may configured to accept products having a diameter ranging from 76 millimeters to 102 millimeters with fourteen production lanes. However, the overall size of the loading units and other components within the system may be altered to accommodate a variety of other geometries.

In some embodiments, the loading units described herein may comprise a thermoplastic material. In some embodiments, the loading units may comprise Delrin material (also referred to as Polyoxymethylene (POM) material). The use of Delrin material may enable the loading units to be easily cleaned. In some embodiments, the cups within the loading units may each comprise aluminum material, but other materials may also be utilized for the cups and the loading units.

In some embodiments, systems may be provided comprising multiple slug loading systems, and one of the slug loading systems may be operative while other may be inoperative. This may be beneficial where a user may seek to use slug loading systems with products of differing sizes. The slug loading system configured to operate with products having the desired size may be made operative while the other slug loading systems may be made inoperative. Having a system with multiple slug loading systems may be beneficial to enable the system to quickly be adjusted for use with products of a different size.

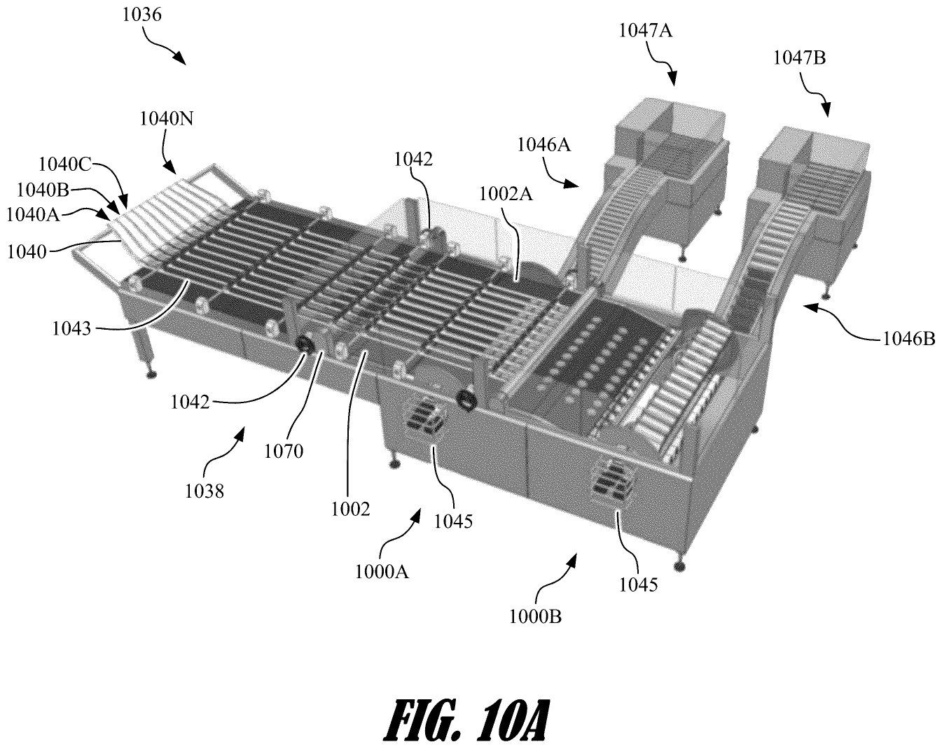

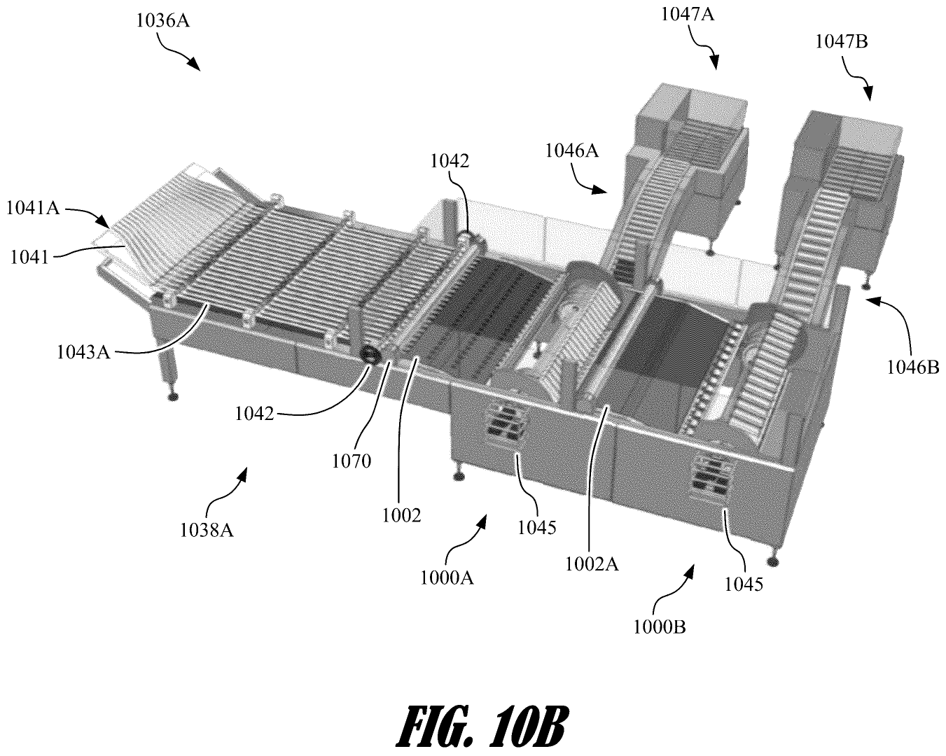

FIG. 10A is a perspective view illustrating an example system 1036 comprising multiple slug loading systems 1000A, 1000B, with a second slug loading system 1000B being operative and with a first slug loading system 1000A being inoperative. The system 1036 may be configured for the production of larger products as compared to the system 1036A illustrated in FIG. 10B, with the system 1036 having a lesser number of lanes and with lanes having larger sizes. Furthermore, the products may be directed to the second slug loading system 1000B, which may be configured to receive products of a larger size relative to the first slug loading system 1000A.

The system 1036 also comprises a conveyors 1002. When the first slug loading system 1000A is inoperative, the conveyor section 1002A may be positioned over the first slug loading system 1000A so that products continue on the conveyor section 1002A to other conveyors 1002 and so that the products eventually reach the second slug loading system 1000B. The first slug loading system 1000A and the second slug loading system 1000B may be similar to the other slug loading systems described herein, and unloading systems similar to those described herein may be provided underneath the slug loading systems 1000A, 1000B. In FIG. 10A, slugs may eventually be transported along the second cross feeder 1046B to the second unit 1047B for further processing, packaging, etc.

An infeed system 1038 may be provided with an infeed channel board 1040. The infeed channel board 1040 may be the location where products are initially received in the system 1036. The infeed channel board 1040 may be sloped downwardly so that the force of gravity urges products towards the conveyors 1002 on the infeed system 1038. The infeed channel board 1040 possesses a plurality of walls, and lanes may be formed between walls. For example, a first lane 1040A, a second lane 1040B, a third lane 1040C, and a final lane 1040N are provided with reference numbers in FIG. 10A. In total, ten lanes may be provided in the infeed channel board 1040, but another number of lanes may be provided in other infeed channel boards. In the infeed channel board 1040, the lanes fan out so that the lanes cover a greater width once they reach the conveyors 1002.

In FIG. 10B, the first slug loading system 1000A is operative and the second slug loading system 1000B is inoperative. The system 1036A is configured for the production of smaller products, with a greater number of lanes and with lanes having a smaller size. Furthermore, the products may be directed to the first slug loading system 1000A, which is configured to receive products of a smaller size relative to the second slug loading system 1000B. Where the first slug loading system 1000A is operative and the second slug loading system 1000B is inoperative, the conveyor section 1002A may be shifted towards the second slug loading system 1000B so that the conveyor section 1002A will not interfere with the operation of the first slug loading system 1000A. Furthermore, where the first slug loading system 1000A is operative, the conveyors 1002 may be adjusted so that product rows may be fed properly to the first slug loading system 1000A. An unloading system may be provided underneath the first slug loading system 1000A that may be similar to other unloading systems described herein, and slugs may eventually be transported along the first cross feeder 1046A to the first unit 1047A for further processing, packaging, etc.

In FIG. 10B, an infeed system 1038A may be provided with an infeed channel board 1041. The infeed channel board 1041 may be the location where products may be initially received in the system 1036A. The infeed channel board 1041 may be sloped downwardly so that the force of gravity urges products towards the conveyors 1002 on the infeed system 1038A. The infeed channel board 1041 possesses a plurality of walls, and lanes 1041A may be formed between walls. In total, twenty-two lanes 1041A may be provided in the infeed channel board 1041, but another number of lanes 1041A may be provided in other infeed channel boards. In the infeed channel board 1041, the lanes 1041A fan out so that the lanes 1041A cover a greater width once they reach the conveyors 1002.

As illustrated in both FIGS. 10A and 10B, the system 1036 may include covers 1045 over the gearmotors to prevent users or other objects from unintentionally contacting or damaging the gearmotors. The covers 1045 may be provided in the form of metal cages, but the covers 1045 may possess other forms. Additionally, the system 1036 comprises handles 1042 on both sides of the conveyors 1002. One or more of the handles 1042 may be adjusted to alter the positioning of the guides 1043 in FIG. 10A or the guides 1043A in FIG. 10B. By doing so, the width and positioning of the lanes may be adjusted so that products may properly be directed towards cups of the first slug loading system 1000A or the second slug loading system 1000B.

Additionally, as illustrated in both FIGS. 10A and 10B, an alignment mechanism 1070 may be provided. The alignment mechanism 1070 may ensure that the products may generally be aligned in rows. In some embodiments, the alignment mechanism 1070 may include one or more sensors such as position sensors. For example, an individual sensor may be provided for each product within a row of products to ensure that the products are aligned appropriately. In some embodiments, two or more sensors may be provided for each product within a row of products to ensure that the products are aligned appropriately, and this redundancy may provide an enhanced degree of quality control for the system. In some embodiments, the alignment mechanism 1070 may comprise a rotatable bar with extensions protruding radially outwardly from the rotatable bar each of the products of a given row may come in contact with the extensions, and the rotatable bar may be rotated to move the extensions out of the way of the products in a given row so that each of the products in the row may be allowed to proceed at approximately the same time and at the same distance away from the slug loading systems. In some embodiments, the alignment mechanism 1070 may simply include retractable extensions, and the retractable extensions may be extended initially until products are detected by sensors at appropriate locations retracted when each of the products in a given row are positioned appropriately so that the products may proceed further along the conveyors 1002.

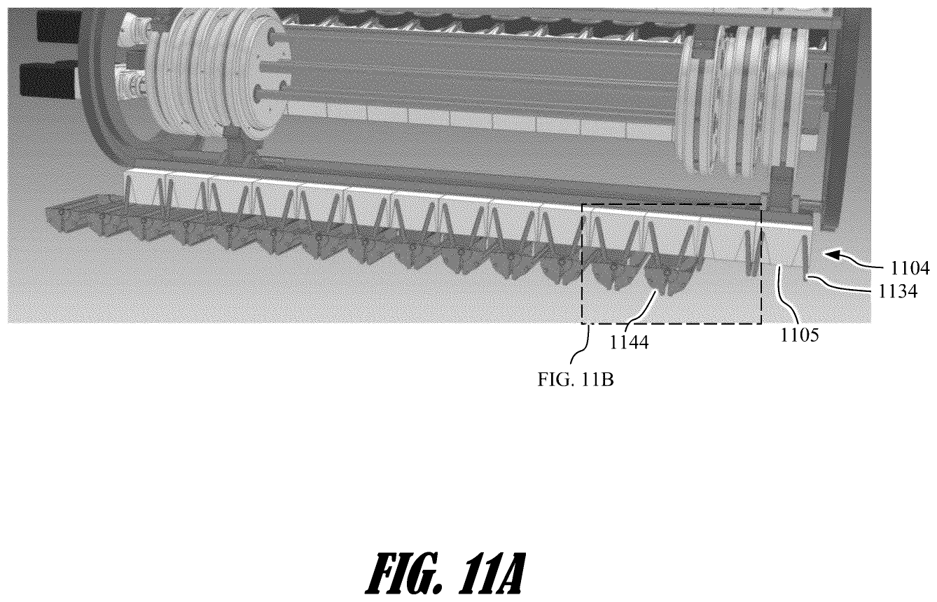

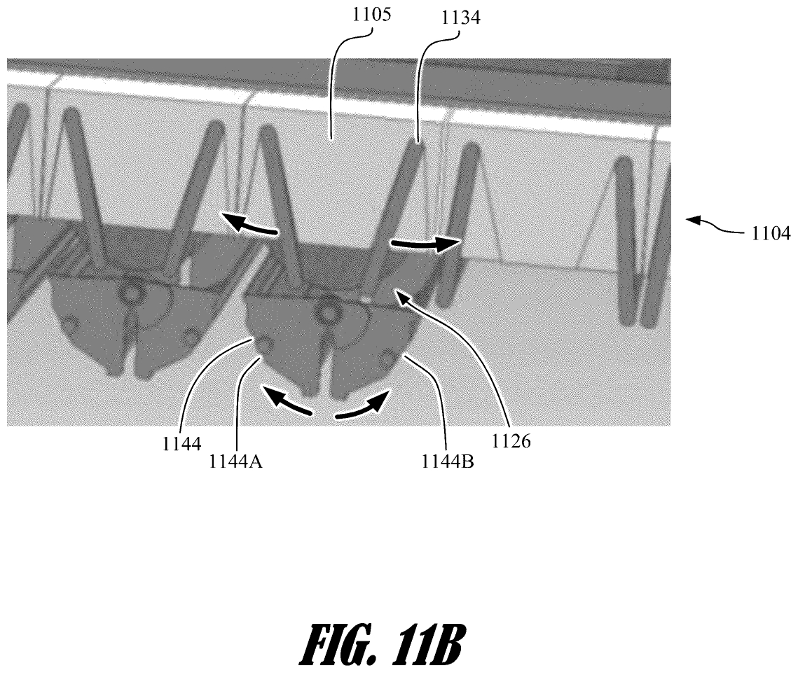

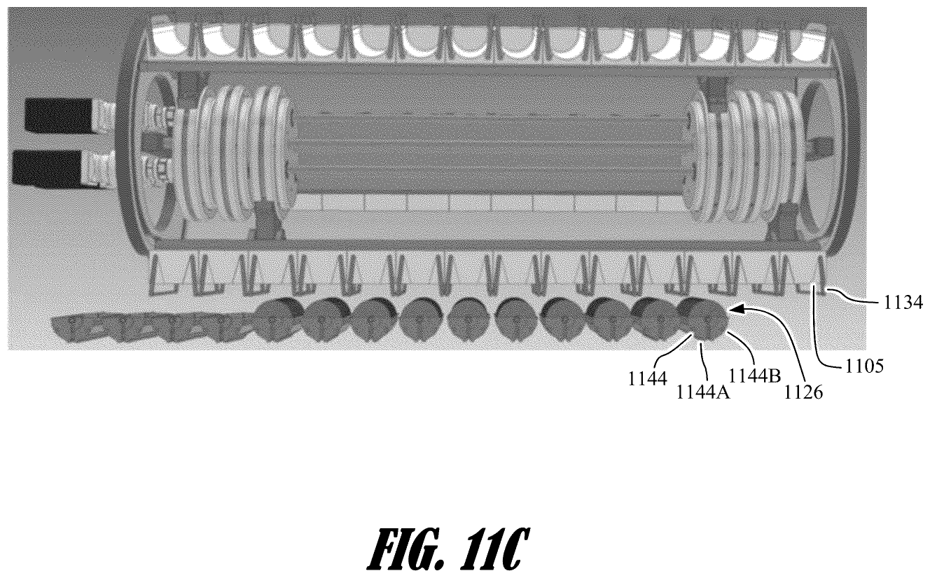

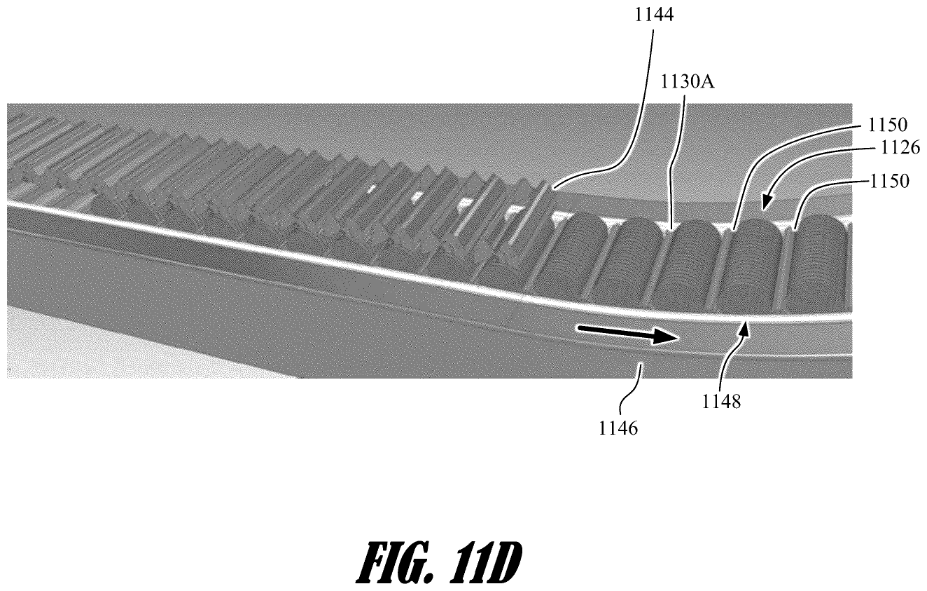

In some embodiments, the unloading systems 130 may comprise intermediate cups 1144. Exemplary intermediate cups 1144 are illustrated in FIGS. 11A-11D. Looking first at FIG. 11A, slugs 1126 (see FIG. 11B) are illustrated that are still being retained in each of the cups 1105 of the loading unit 1104. The gates 1134 on the cups 1105 may be retained in a closed position to retain the slugs 1126 within the cups 1105. Intermediate cups 1144 may be provided below each of the cups 1105 that are holding slugs 1126.

Further details of the intermediate cups 1144 are illustrated in the enhanced view of FIG. 11B. In FIG. 11B, the intermediate cups 1144 are illustrated with a first portion 1144A and a second portion 1144B. As illustrated by the arrows located proximate to the gates 1134, the gates 1134 may be rotated to an opened state to allow the slugs 1126 to fall a small distance to the intermediate cups 1144. In FIGS. 11A and 11B, the intermediate cups 1144 are illustrated in a closed state, with the first portion 1144A and the second portion 1144B rotated proximate to each other so that they may hold slugs 1126 in the intermediate cups 1144 when the gates 1134 are opened.

FIG. 11C illustrates the slugs 1126 resting in the intermediate cups 1144 after the gates 1134 are moved to an opened state, with the intermediate cups 1144 provided in a closed state so that they are configured to hold the slugs 1126. Once the slugs 1126 have moved to the intermediate cups 1144, the loading unit 1104 may begin moving along the first cam paths 122 so that the loading unit 1104 may receive further products. Thus, the use of the intermediate cups 1144 may enable the systems to operate at high speeds.

FIG. 11D illustrates the intermediate cups 1144 in an opened state. In this opened state, the intermediate cups 1144 allow the slugs 1126 to be lowered down to a tray 1130A on the cross feeder 1146. The tray 1130A may include slots 1148 defined between walls 1150 in the tray 1130A. Slugs 1126 may be received within the slots 1148, and the slugs 1126 may be transported in the tray 1130A along the cross feeder 1146 to another location where the slugs 1126 may be packaged together or processed further.

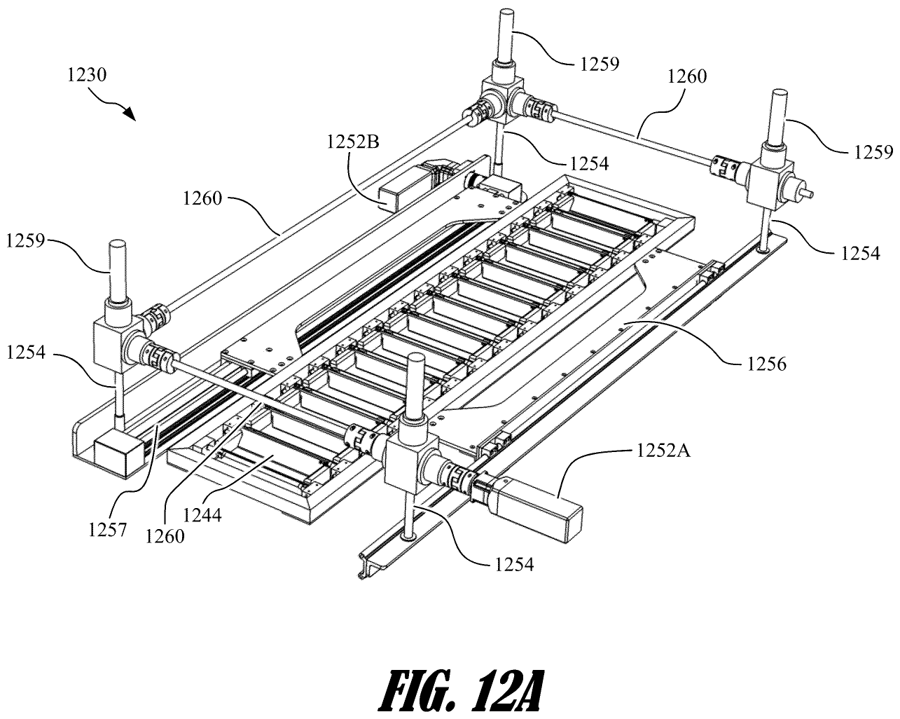

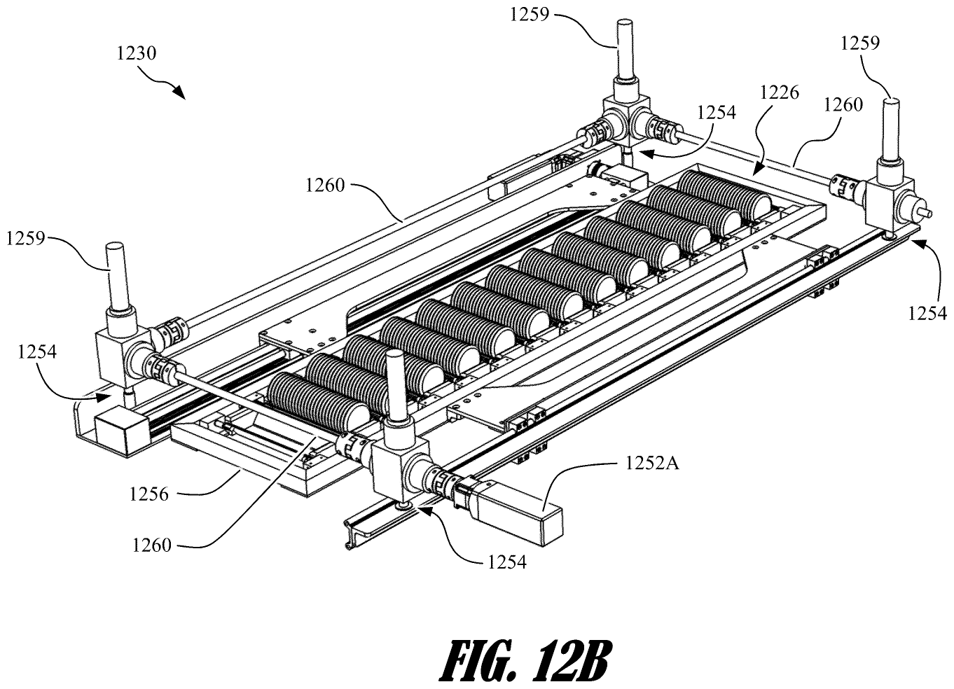

An unloading system 1230 that may be positioned underneath slug loading systems is illustrated in FIGS. 12A and 12B. The unloading system 1230 may handle the products delicately to avoid significant damage or degradation in the products. The unloading system 1230 comprises intermediate cups 1244, a first power mechanism 1252A, a second power mechanism 1252B, retractable bars 1254, rack 1256, and linear actuators 1259. The intermediate cups 1244 may be where slugs 1226 (see FIG. 12B) are received. The linear actuators 1259 may facilitate connection of the unloading system 1230 to a slug loading system 100 (see FIG. 1A) or to another component. The rack 1256 may be connected to the retractable bars 1254 and may be configured to hold the intermediate cups 1244.

Looking first at FIG. 12A, portions of the unloading system 1230 are illustrated where the rack 1256 to which the intermediate cups 1244 may be attached is positioned in a lowered position. In this lowered position, the intermediate cups 1244 may rest slightly above the cross feeder 1146. The intermediate cups 1244 may be moved to an opened state when the rack 1256 is in this lowered position so that damage and degradation of the products in slugs 1226 (see FIG. 12B) may be reduced. The rack 1256 may be positioned in the lowered position using the first power mechanism 1252A. The first power mechanism 1252A may be configured to generate movement in the unloading system 1230 pneumatically, hydraulically, or in other ways. The first power mechanism 1252A may be connected by a series of lines 1260 to cause movement at each of the retractable bars 1254. In the lowered position of FIG. 12A, the retractable bars 1254 may be in extended positions so that the rack 1256 is positioned in a lowered position.

A second power mechanism 1252B may also be provided. The second power mechanism 1252B may be configured to cause the rack 1256 and the intermediate cups 1244 attached to the rack 1256 to move horizontally along the rail 1257. The rack 1256 and the intermediate cups 1244 may shift horizontally relative to linear actuators 1259. The movement of the intermediate cups 1244 may be beneficial to temporarily match the speed of the cross feeder 1146 below, and this may be helpful where the cross feeder 1146 is continuously moving. Movement of the intermediate cups 1244 may also be beneficial to appropriately align the intermediate cups with slots 1148 (see FIG. 11D) defined in a tray 1130A (see FIG. 11D) on the cross feeder 1146.

In FIG. 12B, the retractable bars 1254 may be in retracted positions so that the rack 1256 is positioned in an elevated position. The retractable bars 1254 may be retracted into the linear actuator 1259 or into another component. In this elevated position, the intermediate cups 1244 may be positioned slightly below the unloading position for loading units in the slug loading system. Thus, the amount of damage and degradation of products in slugs 1226 may be reduced as the slugs 1226 are lowered from the loading units to the intermediate cups 1244.

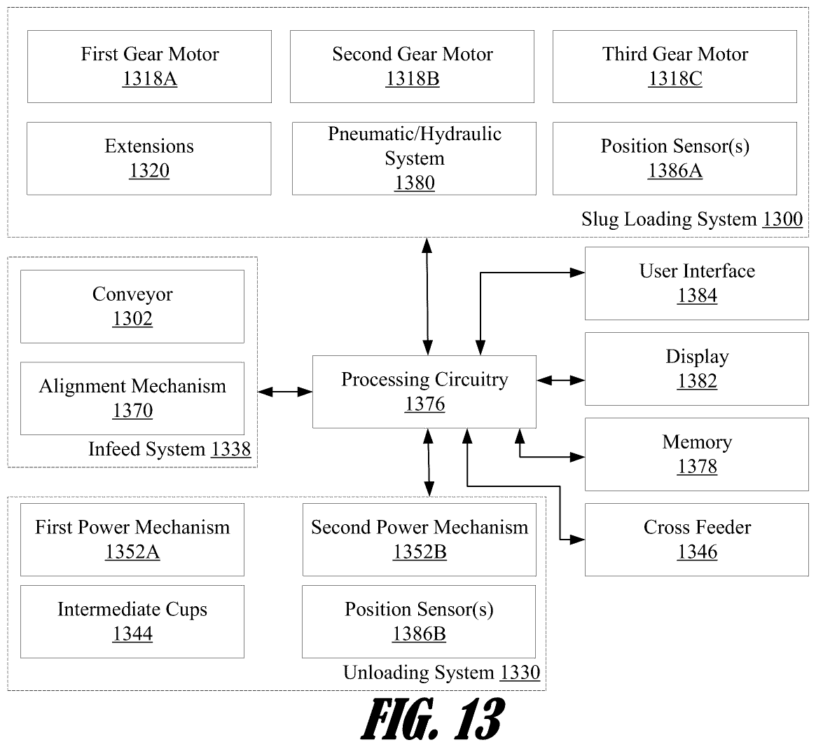

FIG. 13 is a block diagram illustrating various electrical components and other components within example systems described herein. As described herein, the systems may include a slug loading system 1300, an infeed system 1338, an unloading system 1330, and a cross feeder 1346. However, in some embodiments, these subsystems may be combined together or rearranged. Various lines are shown connecting systems and/or components in FIG. 13, but these lines may be rearranged so that they extend between different systems and/or components. These lines may represent signal lines so that signals may be transmitted between the various systems and components to the processing circuitry.

Processing circuitry 1376 may be provided. The processing circuitry 1376 may be any means configured to execute various programmed operations or instructions stored in a memory device (e.g., memory 1378) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processing circuitry 1376 as described herein.

The processing circuitry 1376 may be connected to memory 1378. In an example embodiment, the memory 1378 may include one or more non-transitory storage or memory devices such as, for example, volatile and/or non-volatile memory that may be either fixed or removable. The memory 1378 may be configured to store instructions, computer program code, and other data in a non-transitory computer readable medium for use, such as by the processing circuitry 1376 for enabling the components of the system to carry out various functions in accordance with example embodiments of the present invention. For example, the memory 1378 could be configured to buffer input data for processing by the processing circuitry 1376. Additionally or alternatively, the memory 1378 could be configured to store instructions for execution by the processing circuitry 1376. The memory 1378 may include computer program code that may be configured to, when executed, cause the processing circuitry 1376 to perform various methods described herein. The memory 1378 may serve as a non-transitory computer readable medium having stored thereon software instructions that, when executed by a processor, cause methods described herein to be performed.

The slug loading system 1300 may comprise a first gear motor 1318A, a second gear motor 1318B, and a third gear motor 1318C. In some embodiments, one or more position sensors 1386A may be provided in the slug loading system 1300 to monitor the positioning of components within the slug loading system 1300. The position sensor(s) 1386A may be provided in each of the loading units 104, 106, 108 (see FIG. 2B) in some embodiments. Additionally, the slug loading system 1300 may comprise extensions 1320 and a pneumatic or hydraulic system 1380. The pneumatic/hydraulic system 1380 may be used to control the positioning of the extensions 1320 to cause the gates 134 (see FIG. 2B) on loading units 104, 106, 108 to be opened and closed. Signals from the processing circuitry 1376 may be utilized to control the operation of the pneumatic/hydraulic system 1380 and/or the extensions 1320.

An infeed system 1338 is also illustrated. The infeed system 1338 comprises a conveyor 1302 and an alignment mechanism 1370. The infeed system 1338 also comprises other components as well. Signals from the processing circuitry 1376 may cause the speed of the conveyor 1302 to be changed in some embodiments. The operation of other components in the system may be adjusted based on signals transmitted between the alignment mechanism 1370 and the processing circuitry 1376.

An unloading system 1330 is also illustrated. The unloading system 1330 comprises a first power mechanism 1352A, a second power mechanism 1352B, intermediate cups 1344, and one or more position sensors 1386B. The unloading system 1330 may also comprise other components. The processing circuitry 1376 may send signals to control the operation of these components within the unloading system 1330 and the processing circuitry 1376 may receive signals from the components within the unloading system 1330 as well. Position sensor(s) 1386B may identify the position of the intermediate cups 1344. Additionally or alternatively, the position sensor(s) 1386B may also detect when the intermediate cups 1344 are in an opened state or a closed state. In some embodiments, position sensor(s) may also be provided at the cross feeder 1346 to provide insight into the position of appropriate slots within the cross feeder 1346, and the data from the position sensor(s) at the cross feeder 1346 and the position sensors 1386B at the unloading system 1330 may be used to ensure that slugs in intermediate cups 1344 are appropriately positioned relative to the slots within the cross feeder 1346. Data from these position sensor(s) may also be utilized to generate commands for the first power mechanism 1352A and the second power mechanism 1352B.

A display 1382 and a user interface 1384 are also illustrated in FIG. 13. The display 1382 may be a touch screen display in some embodiments, but the display 1382 may be configured such that it will not be able to receive touch inputs in other embodiments. The display 1382 may be configured to present images or other information and may include or otherwise be in communication with a user interface 1384 configured to receive inputs from a user. The display 1382 may be, for example, a conventional LCD (liquid crystal display), a touch screen display, mobile device, or any other suitable display known in the art upon which images and other information may be displayed. The user interface 1384 may include, for example, a keyboard, keypad, function keys, buttons, a mouse, a scrolling device, input/output ports, a touch screen, or any other mechanism by which a user may interface with the system.

It will be understood that any methods described herein may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 1378 and executed by, for example, the processing circuitry 1376. Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the methods set forth herein.

All references cited in this specification, including without limitation, all papers, publications, patents, patent applications, provisional patent applications, presentations, texts, reports, manuscripts, brochures, books, internet postings, journal articles, and/or periodicals are hereby incorporated by reference into this specification in their entireties, including all figures and tables, to the extent they are not inconsistent with the explicit teachings of this specification. The discussion of the references herein is intended merely to summarize the assertions made by their authors and no admission is made that any reference constitutes prior art. Applicants reserve the right to challenge the accuracy and pertinence of the cited references.

All references cited in this specification, including without limitation, all papers, publications, patents, patent applications, provisional patent applications, presentations, texts, reports, manuscripts, brochures, books, internet postings, journal articles, and/or periodicals are hereby incorporated by reference into this specification in their entireties, including all figures and tables, to the extent they are not inconsistent with the explicit teachings of this specification. The discussion of the references herein is intended merely to summarize the assertions made by their authors and no admission is made that any reference constitutes prior art. Applicants reserve the right to challenge the accuracy and pertinence of the cited references.

What is claimed is:

1. A system for formation of one or more slugs, the system comprising:
a first loading unit having one or more first cups;
a second loading unit having one or more second cups,
wherein the first loading unit and the second loading unit are each configured to receive products therein from a conveyor, wherein the first loading unit and the second loading unit are each configured to move to an unloading position after receiving the products so that the one or more slugs are formed, wherein the first loading unit and the second loading unit are each configured to unload the one or more slugs when the first loading unit and the second loading unit are in the unloading position, and wherein the first loading unit and the second loading unit are independently driven so that the first loading unit and the second loading unit are configured to move relative to each other.

2. The system of claim 1, further comprising a third loading unit, wherein the third loading unit is configured to receive the products therein from the conveyor, wherein the third loading unit is configured to move to the unloading position after receiving the products so that at least one slug is formed, wherein the third loading unit is configured to unload the at least one slug when the third loading unit is in the unloading position, and wherein the third loading unit is independently driven so that the third loading unit is configured to move relative to the first loading unit and the second loading unit.

3. The system of claim 1, wherein the first loading unit and the second loading unit are each configured to receive the products therein from a conveyor at different times, wherein the first loading unit and the second loading unit are each configured to reach an unloading position at different times, and wherein the first loading unit and the second loading unit are each configured to unload the one or more slugs at different times.

4. The system of claim 1, further comprising:
a wall defining a first cam path that is configured to assist in controlling positioning and orientation of the first loading unit and the second loading unit.

5. The system of claim 4, wherein the first loading unit comprises a first follower and the second loading unit comprises a second follower, and wherein the first cam path is configured to receive the first follower and the second follower within the first cam path.

6. The system of claim 4, wherein the first cam path is configured to cause the first loading unit and the second loading unit to be positioned proximate to the conveyor to receive the products from the conveyor, and wherein the first cam path is configured to position and orient the first loading unit and the second loading unit so that they do not contact the conveyor.

7. The system of claim 6, wherein, while actively receiving the products, the first loading unit and the second loading unit are moved after the products are received to enable further products to be stacked on top of other products that have already been received in the first loading unit or the second loading unit.

8. The system of claim 4, further comprising an unloading system, wherein the first cam path is configured to cause the first loading unit and the second loading unit to be positioned proximate to the unloading system when in an unloading position, and wherein the first cam path is configured to position and orient the first loading unit and the second loading unit so that they do not contact the unloading system.

9. The system of claim 8, wherein the unloading system comprises intermediate cups, wherein the intermediate cups are configured to be in a closed state and raised to an elevated position to receive the one or more slugs from the first loading unit or the second loading unit when the first loading unit or the second loading unit are in the unloading position, wherein the intermediate cups are configured to be lowered to a lowered position, and wherein the intermediate cups are configured to shift to an opened state when in the lowered position to enable the one or more slugs to be released to a cross feeder below.

10. The system of claim 1, wherein the first loading unit and the second loading unit each comprise one or more gates to selectively retain products in the one or more first cups and the one or more second cups.

11. The system of claim 10, further comprising:
a second cam path defined in the wall,
wherein the first loading unit comprises a first pin, wherein the second cam path is positioned so that the first pin engages the second cam path after the first loading unit has finished receiving the products to form the one or more slugs, and wherein engagement between the second cam path and the first pin causes the one or more gates of the first loading unit to move to a closed position to retain the one or more slugs in the first loading unit.

12. The system of claim 1, wherein the second cam path is positioned so that the first pin stops engaging the second cam path once the first loading unit has reached the unloading position, and wherein disengagement between the second cam path and the first pin causes the one or more gates of the first loading unit to move to an opened position to allow the one or more slugs to be released from the first loading unit.

13. The system of claim 1, wherein the first loading unit is driven by a first set of at least two gear boxes, a first gearmotor, and a first drive shaft.

14. The system of claim 13, wherein the second loading unit is driven by a second set of at least two gear boxes, a second gearmotor, and a second drive shaft.

15. The system of claim 1, wherein the first loading unit and the second loading unit are each configured to receive rows of products therein from a conveyor, and wherein the system is configured to receive 100 rows of products per minute.

16. The system of claim 15, wherein the system is configured to receive 230 rows of products per minute.

17. A system for formation of one or more slugs, the system comprising:
a first slug loading system comprising:
a first loading unit having one or more first cups; and
a second loading unit having one or more second cups,
a conveyor; and
an unloading system;
wherein the first loading unit and the second loading unit are each configured to receive products therein from the conveyor, wherein the first loading unit and the second loading unit are each configured to move to an unloading position after receiving the products so that the one or more slugs are formed, wherein the first loading unit and the second loading unit are each configured to unload the one or more slugs when the first loading unit and the second loading unit are in the unloading position, and wherein the first loading unit and the second loading unit are independently driven so that the first loading unit and the second loading unit are configured to move relative to each other.

18. The system of claim 17, further comprising a second slug loading system comprising a third loading unit having one or more third cups and a fourth loading unit having one or more fourth cups, wherein the third loading unit and the fourth loading unit are each configured to receive products therein from the conveyor, wherein the third loading unit and the fourth loading unit are each configured to move to a second unloading position after receiving the products so that the one or more slugs are formed, wherein the third loading unit and the fourth loading unit are each configured to unload the one or more slugs when the third loading unit and the fourth loading unit are in the unloading position, and wherein the third loading unit and the fourth loading unit are independently driven so that the third loading unit and the fourth loading unit are configured to move relative to each other, wherein the first slug loading system is configured to operate with products having a first size, and where the second slug loading system is configured to operate with products having a second size.

19. The system of claim 17, wherein only one of the first slug loading system or the second slug loading system is operative at any given time.
